(19) United States
(12) Patent Application Publication
(10) Pub. No.: US 2025/0253114 A1
(43) Pub. Date: Aug. 7, 2025

(54) ARC-EXTINGUISHING MECHANISM

(71) Applicant: Chint Low Voltage Electrical Technology Co., Ltd., Songjiang District, Shanghai (CN)

(72) Inventors: Denggui AO, Songjiang District, Shanghai (CN); Xiaoqin YUAN, Songjiang District, Shanghai (CN); Dengyu LU, Songjiang District, Shanghai (CN); Lijun YAN, Songjiang District, Shanghai (CN); Hao FU, Songjiang District, Shanghai (CN); Yongfu XU, Songjiang District, Shanghai (CN); Yongfeng GUO, Songjiang District, Shanghai (CN); Fu HUANG, Songjiang District, Shanghai (CN)

(21) Appl. No.: 18/856,533

(22) PCT Filed: Jun. 17, 2023
(86) PCT No.: PCT/CN2023/100910

§ 371 Date: Oct. 11, 2024

(30) Foreign Application Priority Data
Jul. 4, 2022 (CN) 202210781067.8

(51) Int. Cl. H01H 73/18

(52) U.S. Cl. CPC H01H 73/18

(57) ABSTRACT

An arc-extinguishing mechanism that includes an arc-extinguishing chamber. The arc-extinguishing chamber includes two partition plates and a plurality of arc-extinguishing grids arranged between the two partition plates. An arc-striking sheet which cooperates with a moving contact or a static contact is arranged at the top of the arc-extinguishing grids. The arc-extinguishing mechanism further includes a first magnetizing mechanism that has two oppositely arranged first magnetizing sheets on two sides of the plurality of arc-extinguishing grids, and an arc-striking structure arranged at the bottom of the arc-extinguishing grids. The first magnetizing sheets are parallel to the partition plates. The first magnetizing sheets, the arc-striking structure and the arc-striking sheets form a first magnetic loop used for generating a pushing force in the direction of an exhaust port of the arc-extinguishing chamber to an electric arc entering the arc-extinguishing chamber.

### TECHNICAL FIELD

The present invention relates to the field of low-voltage electrical appliances, and more particularly to an arc-extinguishing mechanism.

### BACKGROUND

A circuit breaker is mainly used to carry normal working current, and also needs to have the capability of breaking a fault current in a circuit. An electric arc will be generated during the breaking process of a large fault current. The electric arc will have adverse impacts on a current-carrying circuit and the circuit breaker, and even directly damages current-carrying equipment in serious cases. Therefore, how to quickly transfer and eliminate the electric arc is very important, especially for DC circuit breaker products, how to transfer and eliminate the electric arc has become the a key and difficult point in the design.

### SUMMARY

An objective of the present invention is to overcome the defects of the prior art and provide a circuit breaker with a strong arc-extinguishing capability and convenience in assembly.

In order to achieve the above object, the present invention adopts the following technical solutions:

An arc-extinguishing mechanism, comprising an arc-extinguishing chamber, wherein the arc-extinguishing chamber comprises two partition plates and a plurality of arc-extinguishing grids arranged between the two partition plates; an arc-striking sheet which cooperates with a moving contact or a static contact is arranged at the top of the arc-extinguishing grids; the arc-extinguishing mechanism further comprises a first magnetizing mechanism; the first magnetizing mechanism comprises two first magnetizing sheets that are oppositely arranged on two sides of the plurality of arc-extinguishing grids, and an arc-striking structure is arranged at the bottom of the arc-extinguishing grids; the first magnetizing sheets are parallel to the partition plates; the first magnetizing sheets, the arc-striking structure and the arc-striking sheets form a first magnetic loop; and the first magnetic loop is used for generating a pushing force in a direction of an exhaust port of the arc-extinguishing chamber to an electric arc entering the arc-extinguishing chamber.

Preferably, comprising the two arc-extinguishing chambers, wherein each of the two arc-extinguishing chambers is provided with the first magnetizing mechanism.

Preferably, the arc-extinguishing grids at the bottom of the two arc-extinguishing chambers are powered on to form the arc-striking structure, or the arc-extinguishing grids at the bottom of the two arc-extinguishing chambers are integrally molded to form the arc-striking structure.

Preferably, the arc-extinguishing mechanism further comprises a second magnetizing mechanism; the second magnetizing mechanism comprises two second magnetizing sheets that are arranged oppositely; the two second magnetizing sheets are arranged on two sides of a movement trajectory of an opening position and a closing position of the moving contact; the second magnetizing sheets and the arc-striking sheets form a second magnetic loop; and the second magnetic loop is used for generating a pushing force in a direction of a gas inlet of the arc-extinguishing chamber to an electric arc generated in disconnection.

Preferably, the arc-extinguishing chamber is arranged on the inner side of a housing, and the first magnetizing sheets are arranged on the outer side of the housing.

Preferably, further comprising a magnetic block, wherein the magnetic block is arranged on a side of the static contact away from the moving contact and is located between the two second magnetizing sheets.

Preferably, the static contact includes a contact plate. The contact plate includes a connecting portion arranged a static contact point. The magnetic block is mounted on a side of the connecting portion away from the moving contact.

Preferably, comprising two arc-striking sheets, which are a first arc-striking sheet and a second arc-striking sheet respectively; the first arc-striking sheet and the second arc-striking sheet cooperate with the static contact and the moving contact respectively; the arc-striking sheet comprises a contact portion and an arc-striking portion that are connected in a bending manner, wherein the contact portion of the first arc-striking sheet is connected to the static contact, and the arc-striking portion of the first arc-striking sheet extends to the upper side of one of the arc-extinguishing chambers; and an arc angle of the moving contact is in contact fit with the contact portion of the second arc-striking sheet when the moving contact is fully opened, and the arc-striking portion of the second arc-striking sheet extends to the upper side of the other arc-extinguishing chamber.

Preferably, each arc-striking sheet is provided with an arc-striking ditch.

Preferably, a first groove and a second groove are formed on the outer sides of two opposite side walls of the housing; and the first magnetizing sheets and the second magnetizing sheets are respectively mounted in the first groove and the second groove, which are covered with an insulating plate.

Preferably, a gas inlet is formed at one end of each of the two arc-extinguishing chambers that are close to each other, and a gas outlet is formed at one end of each of the two arc-extinguishing chambers that are away from each other; the two groups of arc-extinguishing chambers are symmetrically arranged at two ends of the bottom of the housing; each side wall at two ends of the housing is provided with two gas outlets that are symmetrically formed; and the two gas outlets correspond respectively to exhaust ports of the two groups of arc-extinguishing chambers.

Preferably, guide surfaces are respectively arranged at the upper and lower ends of the two sides of the gas outlets and the guide surfaces have inclined or curved shapes.

Preferably, an arc-extinguishing groove is respectively formed at the end parts of at least part of arc-extinguishing grids in each group of arc-extinguishing chambers that are close to the other arc-extinguishing chamber; a diffusion groove that is communicated with the bottom of the arc-striking groove is formed on each arc-extinguishing grid; and a maximum inner diameter of the diffusion groove is greater than an inner diameter at the bottom of the diffusion groove.

Preferably, the two groups of arc-extinguishing chambers are symmetrically arranged at two ends of the bottom of the housing; a trip is arranged on the top side of one group of arc-extinguishing chambers; the static contact is arranged on the top side of the other group of arc-extinguishing chambers; and the moving contact is located between the trip and the static contact.

Preferably, the housing is provided with a fourth confined space accommodating the arc-extinguishing chambers, and a first confined space accommodating the moving contact; a rotating shaft connected to the moving contact is arranged in the first confined space; the moving contact is located in the first confined space; one end of the moving contact which is provided with the moving contact point extends into the fourth confined space; the insulation partitioning between the first confined space and the fourth confined space during the movement of the moving contact is implemented through a swing baffle arranged on the moving contact in the shape of an arc surface shape and an insulating chute arranged on the housing and matched with the swing baffle.

Preferably, a second confined space for accommodating the static contact is arranged in the housing; and the static contact is arranged in the second confined space, and only a static contact point of the static contact is exposed in the fourth confined space.

Preferably, a third confined space for accommodating the trip is formed in the housing; the trip is connected to a first wiring sheet; the moving contact is connected to a second wiring sheet; the first wiring sheet is connected to the second wiring sheet; the first confined space and the third confined space are separated by a first baffle and a second baffle that are in a staggered arrangement; and a wiring groove for accommodating the first wiring sheet and the second wiring sheet is formed between the first baffle and the second baffle.

Preferably, the arc-extinguishing grids of the two groups of arc-extinguishing chambers are mounted on the same two partition plates.

According to the arc-extinguishing mechanism of the present invention, a magnetic loop for driving the electric arc to move is formed by using the arc-striking sheets on the basis of the existing arc-striking sheets guiding the electric arc. The first magnetizing sheets, the arc-striking sheets and the arc-extinguishing grids at the bottom of the arc-extinguishing chamber form the first magnetic loop. The first magnetic loop is used for generating a pushing force in a direction of the exhaust port of the arc-extinguishing chamber to the electric arc entering the arc-extinguishing chamber, which can accelerate the speed of electric arc movement, and further increases the electric arc extinguishing speed.

Furthermore, the second magnetizing sheets and the arc-striking sheets form a second magnetic loop. The second magnetic loop is used for generating a pushing force in the direction of the gas inlet, acting on the electric arc that forms when the moving and static contacts are disconnected. Such a force can further increase an electric arc extinguishing speed.

### BRIEF DESCRIPTION OF THE DRAWINGS

FIG. 1 is a schematic structural diagram of an arc-extinguishing mechanism;

FIG. 2 is a schematic structural diagram of a housing;

FIG. 3 is a schematic structural diagram of a moving contact;

FIG. 4 is a schematic structural diagram of an arc-extinguishing grid;

FIG. 5 is a schematic structural diagram of a first arc-striking sheet;

FIG. 6 is a schematic structural diagram of a second arc-striking sheet;

FIG. 7 is a schematic structural diagram of an arc-extinguishing chamber;

FIG. 8 is another schematic structural diagram of the arc-extinguishing grid;

FIG. 9 is a schematic structural diagram of an insulating plate;

FIG. 10 is a schematic diagram of a magnetic field in a circuit breaker; and

FIG. 11 is a schematic diagram of a first magnetic loop and a second magnetic loop.

### DETAILED DESCRIPTION OF THE INVENTION

The specific implementation of a circuit breaker of the present invention will be further described below with reference to the embodiments given in accompanying drawings. The circuit breaker of the present invention is not limited to the description of the following embodiments.

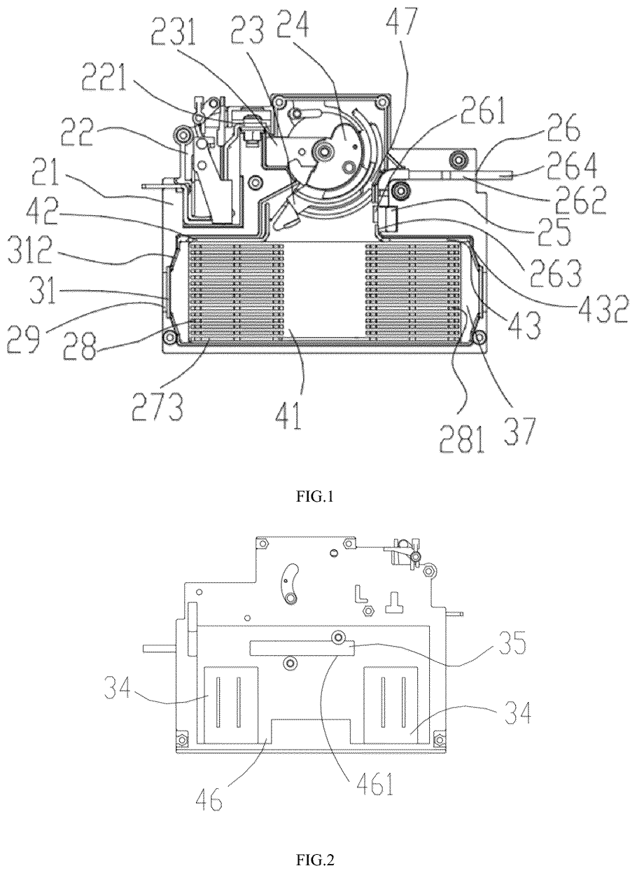

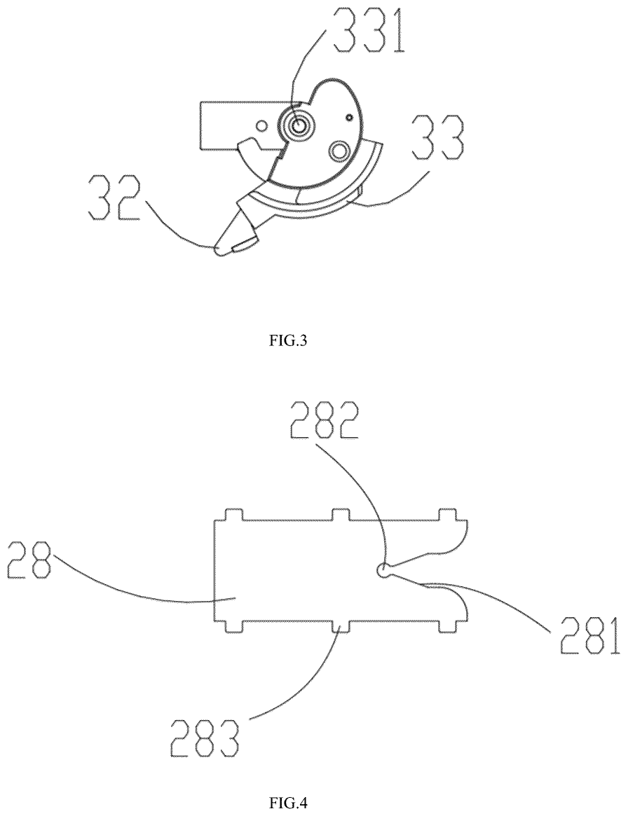

As shown in FIGS. 1-2, the present invention provides an arc-extinguishing mechanism, including an arc-extinguishing chamber 37, wherein the arc-extinguishing chamber 37 includes two partition plates 41 and a plurality of arc-extinguishing grids 28 arranged between the two partition plates 41. An arc-striking sheet which cooperates with a moving contact 23 or a static contact 26 is arranged at the top of the arc-extinguishing grids 28. The arc-extinguishing mechanism further includes a first magnetizing mechanism. The first magnetizing mechanism includes two first magnetizing sheets 34 that are oppositely arranged on two sides of the plurality of arc-extinguishing grids 28. The first magnetizing sheets 34 are parallel to the partition plates 41. The first magnetizing sheets 34, the arc-striking sheets and the arc-extinguishing grids 28 at the bottom of the arc-extinguishing chamber 37 form a first magnetic loop. The first magnetic loop is used for generating a pushing force in a direction of an exhaust port of the arc-extinguishing chamber 37 to an electric arc entering the arc-extinguishing chamber 37.

According to the arc-extinguishing mechanism of the present invention, a magnetic loop for driving the electric arc to move is formed by using the arc-striking sheets on the basis of the existing arc-striking sheets guiding the electric arc. Since the first magnetizing sheets 34, the arc-striking sheets and the arc-extinguishing grids 28 at the bottom of the arc-extinguishing chamber 37 form the first magnetic loop, and the first magnetic loop is used for generating a pushing force in a direction of the exhaust port of the arc-extinguishing chamber to the electric arc entering the arc-extinguishing chamber, a speed of electric arc movement can be accelerated, and an electric arc extinguishing speed is further increased.

FIG. 1 shows a circuit breaker. The circuit breaker in this embodiment includes an arc-extinguishing mechanism of the present invention. The arc-extinguishing mechanism in this embodiment includes two arc-extinguishing chambers 37 and two arc-striking sheets, wherein each of the two arc-extinguishing chambers 37 is provided with the first magnetizing mechanism. Specifically, the arc-extinguishing chambers 37, a trip 22, a moving contact 23 and a static contact 26 are arranged in the housing 21 of the circuit breaker, two groups of arc-extinguishing chambers 37 are arranged at the bottom of the housing 21, and the trip 22, the moving contact 23 and the static contact 26 are arranged on the top side of the arc-extinguishing chamber 37. The two groups of arc-extinguishing chambers 37 are a left arc-extinguishing chamber and a right arc-extinguishing chamber respectively. In drawings, left and right sides of the two groups of arc-extinguishing chambers 37 are symmetrically arranged at two ends of the bottom of the housing 21. Each group of arc-extinguishing chambers 37 includes a plurality of arc-extinguishing grids 28 which are laminated at intervals. A gas inlet is formed at one end of each of the two arc-extinguishing chambers (37) that are close to each other, and a gas outlet is formed at one end of each of the two arc-extinguishing chambers (37) that are away from each other. The trip 22 is arranged on the top side of the left arc-extinguishing chamber, the static contact 26 is arranged on the top side of the right arc-extinguishing chamber, and the moving contact 23 is located between the trip 22 and the static contact 26. A swing trajectory when the moving contact 23 is broken is to swing from a position close to the right arc-extinguishing chamber to a position close to the left arc-extinguishing chamber. When the moving contact 23 and the static contact 26 are located at the top side of the right arc-extinguishing chamber when they are in contact and closed, and the moving contact 23 is located at the top side of the left arc-extinguishing chamber while it is fully opened. The two arc-striking sheets are a first arc-striking sheet 42 and a second arc-striking sheet 43 respectively. The first arc-striking sheet 42 and the second arc-striking sheet 43 cooperate with the static contact 26 and the moving contact 23 respectively, and are used for striking an electric arc, which is generated when the moving contact 23 and the static contact 26 are disconnected, into the two arc-extinguishing chambers 37 respectively. The first arc-striking sheet 42 is located on the top side of the left arc-extinguishing chamber and is located between the trip 22 and the left arc-extinguishing chamber. The second arc-striking sheet 43 is located on the top side of the right arc-extinguishing chamber and is located between the static contact 26 and the right arc-extinguishing chamber.

As shown in FIG. 1, two gas outlets 29 are also symmetrically formed in the left and right sides of the housing 21, that is, side walls of two ends of the housing 21; and two gas outlets 29 correspondingly cooperate with exhaust ports of the two groups of arc-extinguishing chambers 37 respectively; and a gas discharged from the exhaust ports of the two groups of arc-extinguishing chambers 37 is discharged out of the housing 21 from the two gas outlets 29 respectively. Preferably, guide surfaces 312 are respectively arranged at upper and lower ends of the gas outlets 29 on two sides, and the guide surface 312 has an inclined or curved shape, which can accelerate the discharge of a hot airflow generated by the electric arc from the gas outlets 29. Preferably, an arc baffle 31 is arranged at each gas outlet 29; the arc baffle 31 is provided with a plurality of small exhaust holes; and the arc baffle 31 is used for blocking metal particles.

As shown in FIGS. 1, and 5-6, each arc-striking sheet includes a contact portion 433 and an arc-striking portion 432 that are connected in a bending manner, wherein the contact portion 433 of the first arc-striking sheet 42 is connected to the static contact 26, and the arc-striking portion 432 of the first arc-striking sheet 42 extends to the upper side of one of the arc-extinguishing chambers 37 (right arc-extinguishing chamber); and an arc angle 32 of the moving contact 23 is in contact fit with the contact portion 433 of the second arc-striking sheet 43 when the moving contact 23 is fully opened, and the arc-striking portion 432 of the second arc-striking sheet 43 extends to the upper side of the other arc-extinguishing chamber 37 (left arc-extinguishing chamber).

Specifically, the contact portion 433 of the second arc-striking sheet 43 is connected to a connecting portion 263 below a static contact point 261 on a static contact plate 262 by means of welding or other means, such that the contact portion may be in close contact connection with the connecting portion. The arc-striking portion 432 of the second arc-striking sheet 43 extends to the top side of the right arc-extinguishing chamber 37 and is basically parallel to the arc-extinguishing grid 28. As shown in FIGS. 1 and 11, the two first magnetizing sheets 34 of the first magnetizing mechanism correspond to the arc-extinguishing grids 28 of the corresponding arc-extinguishing chamber 37, and top side edges of the two first magnetizing sheets 34 of the first magnetizing mechanism correspond to side edges of the arc-striking portion 432 of the second arc-striking sheet 43 located on the top side of the right arc-extinguishing chamber 37, so that the arc-striking portion 432 of the second arc-striking sheet 43 located at the top side of the right arc-extinguishing chamber 37 and longitudinal cross-sections of the corresponding two first magnetizing sheets 34 are U-shaped. The arc angle 32 of the moving contact 23 is in contact fit with the contact portion 433 of the first arc-striking sheet 43 when the moving contact 23 is fully opened, and the arc-striking portion 432 of the first arc-striking sheet 42 extends to the top side of the left arc-extinguishing chamber 37. The top side edges of the two first magnetizing sheets 34 correspond to the side edges of the arc-striking portion 432 of the first arc-striking sheet 42 located at the top side of the left arc-extinguishing chamber 37, and a part of the arc-striking portion 432 of the first arc-striking sheet 42 which is located above the left arc-extinguishing chamber 37 and the longitudinal cross-sections of the corresponding two first magnetizing sheets 34 are U-shaped.

As shown in FIGS. 1, 8, and 10, the arc-extinguishing grids 28 at the bottoms of the two arc-extinguishing chambers 37 are powered on or, are of an arc-striking structure 27 that is integrally molded. Specifically, the arc-extinguishing grids 28 of the two groups of arc-extinguishing chambers 37 are mounted on the same two partition plates 41, and two sides of the arc-extinguishing grids 28 of the two groups of arc-extinguishing chambers 37 are respectively connected to the two partition plates 41 through riveting or other means. The two partition plates 41 are connected into a whole, which can not only reduce the difficulty of assembly, but also can improve the air tightness of the arc-extinguishing chambers 37, and is more conducive to an air blowing effect on the electric arc. Preferably, the partition plates 41 are made of a gas-producing insulating material. The gas-producing insulating material can also produce a gas based on the insulation so as to accelerate the flow of air in the arc-extinguishing chambers 37, which is also conducive to the air blowing effect on the electric arc.

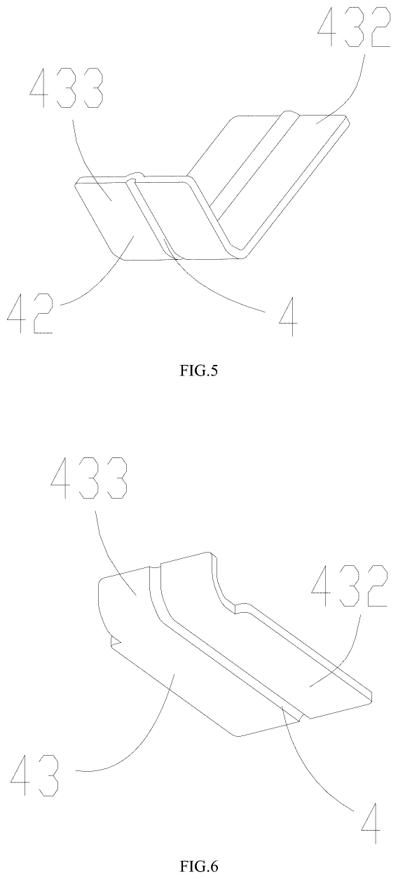

As shown in FIG. 4, each arc-extinguishing chamber 37 includes a plurality of arc-extinguishing grids 28 which are laminated at intervals. Arc-striking grooves 281 are respectively formed at end parts of at least part of the arc-extinguishing grids 28 of each group of arc-extinguishing chambers 37 close to the other arc-extinguishing chambers 37. The arc-striking grooves 281 of the arc-extinguishing grids 28 of the two groups of arc-extinguishing chambers 37 are arranged oppositely. The gas inlet of each arc-extinguishing chamber 37 is formed at one end of the arc-extinguishing chamber 27 that is provided with the arc-striking groove 281. A diffusion groove 282 that is communicated with the bottom of the arc-striking groove 281 is formed in each arc-extinguishing grid 28. A maximum inner diameter of the diffusion groove 282 is greater than an inner diameter of the bottom of the diffusion groove 282. In this embodiment, the diffusion groove 282 is circular or polygonal. When the electric arc moves through the arc-striking groove 281 to the diffusion groove 282, the electric arc energy can be diffused at the edge of the diffusion groove 282, which is more conducive to extinguishing the electric arc. A plurality of arc-extinguishing grids 28 of the two groups of arc-extinguishing chambers 37 which is farthest away from the moving contact 23 are connected to form an integrated structure and are not provided with the arc-striking grooves 281 for forming the arc-striking grids 27. In this embodiment, the arc-extinguishing grids 28 of the two groups of arc-extinguishing chambers 37 which are farthest away from the moving contact 23 are connected to form the arc-striking grid 27. The arc-striking grid 27 can elongate the electric arc, and is more conducive to extinguishing the electric arc.

As shown in FIG. 11, the arc-extinguishing mechanism further includes a second magnetizing mechanism. The second magnetizing mechanism includes two second magnetizing sheets 35 that are arranged oppositely. The two second magnetizing sheets 35 are arranged on two sides of a movement trajectory of an opening position and a closing position of the moving contact. Further, the second magnetizing sheets 35 and the arc-striking sheets form a second magnetic loop. The second magnetic loop is used for forming a pushing force in a direction in the gas inlet to the electric arc generated when the moving and static contacts are disconnected, which can further increase an electric arc extinguishing speed. In particular, through the combination of the arc-striking sheets, the first magnetizing mechanism and the second magnetizing mechanism, the second magnetic loop formed by the second magnetizing mechanism is used for pushing the generated electric arc into the arc-extinguishing chamber in the direction of the gas inlet, and the arc-striking sheets play a guiding role; and the first magnetic loop formed by the first magnetizing mechanism pushes the electric arc entering the arc-extinguishing chamber to the direction of the exhaust port, which accelerates the extinguishing of the electric arc.

Specifically, the two first magnetizing mechanisms form two first magnetic loops, which are a right magnetic loop a and a left magnetic loop b respectively. The first arc-striking sheets 42, as well as the first magnetizing sheets 34 and the arc-striking grids 27 close to two sides of the housing of the arc-striking sheet 42 constitute the right magnetic loop a. The second arc-striking sheets 43, as well as the first magnetizing sheets 34 and the arc-striking sheets 27 close to two sides of the housing of the second arc-striking sheet 43 constitute the left magnetic loop b. The second magnetizing sheets 35 on two sides of the housing, the contact portions 433 of the first arc-striking sheet 42 and the second arc-striking sheet 43 and the magnetic block 25 constitute the second magnetic loop c. The second magnetic loop c, the right magnetic loop a and the left magnetic loop b can promote the rapid movement of the electric arc to extinguish. Preferably, each arc-striking sheet is provided with an arc-striking ditch 4 extending to the corresponding arc-extinguishing chamber 37. The arc-striking ditch 4 can guide the electric arc to move toward the arc-extinguishing chamber 37 and accelerate a moving speed of the electric arc in the arc-extinguishing chamber 37.

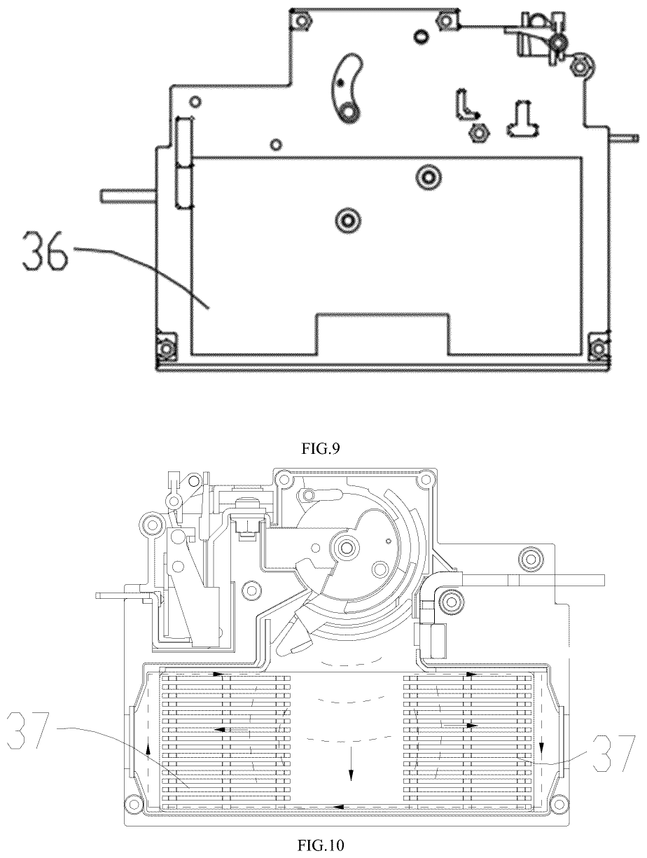

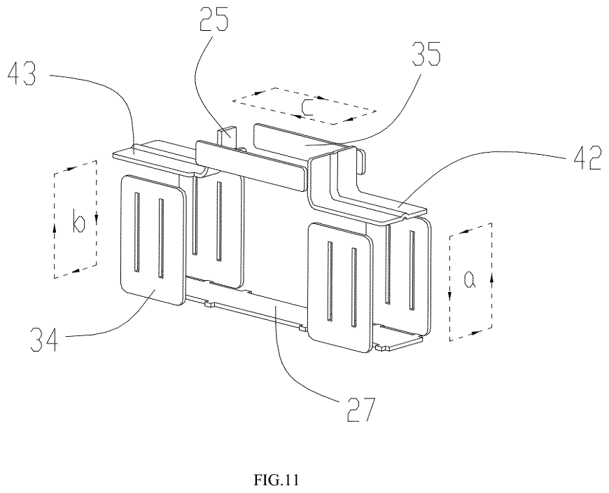

As shown in FIG. 10, the arc-extinguishing chamber 37 is arranged on the inner side of the housing 21, and the first magnetizing sheets 34 are arranged on the outer side of the housing 21. Specifically, a first groove 46 and a second groove 461 are formed on the outer sides of two opposite side walls of the housing 21; and the first magnetizing sheets 34 and the second magnetizing sheets 35 are respectively mounted in the first groove 46 and the second groove 461, and covered with an insulating plate 36. The first magnetizing sheets 34 and the second magnetizing sheets 35 are fixedly mounted outside the housing 21 more easily, and can be reliably isolated from the arc-extinguishing grids 28 in the housing 21 at the same time.

As shown in FIG. 1, the arc-extinguishing mechanism further includes a magnetic block 25, wherein the magnetic block 25 is arranged on a side of the static contact 26 away from the moving contact 23, and is located between the two second magnetizing sheets 35. The two second magnetizing sheets 35 are oppositely arranged on two sides of the moving contact 23, in correspondence to a swing trajectory of the moving contact 23. One ends of the two second magnetizing sheets 35 correspondingly cooperate with two side edges of the magnetic block 25 respectively. The other ends of the two second magnetizing sheets 35 are correspondingly located on two sides of a fully opened position of the moving contact 23 respectively. The two second magnetizing sheets 35 and the magnetic block 25 form a U-shaped structure surrounding the static contact 26. That is, a transverse cross-section of the second magnetizing mechanism is roughly U-shaped. Through the second magnetizing mechanism formed by the magnetic block 25 and the two second magnetizing sheets 35, a magnetic field surrounding the static contact 26 and the moving contact 23 can be formed, such that the magnetic flux density of the magnetic field in the surrounding environment of the static contact 26 is strengthened, and an electrodynamic force that pulls the electric arc toward the arc-extinguishing chamber 37 is increased, which is conducive to the movement of the electric arc to the direction of the arc-extinguishing chamber 37, and also reduces the electric arc stagnation time.

As shown in FIG. 1, the static contact 26 includes a contact plate. The contact plate includes an extension portion 264 extending out of the housing 21 and a connecting portion connected to the extension portion 264. A static contact point 261 is arranged on a side of the connecting portion close to the moving contact 23. The magnetic block 25 is mounted on a side of the connecting portion away from the moving contact 23, and the static contact point 261 is a silver point.

Preferably, as shown in FIG. 1, the housing 21 is formed by an insulating structure and is provided with a first confined space, a second confined space, a third confined space and a fourth confined space. The fourth confined space is located below the first confined space, the second confined space and the third confined space; and the arc-extinguishing chambers 37, the first arc-striking sheets 42 and the second arc-striking sheets 43 are arranged in the fourth confined space.

A rotating shaft 24 connected to the moving contact 23 is arranged in the first confined space. The moving contact 23 is located in the first confined space. One end of the moving contact 23 which is provided with a moving contact point extends into the fourth confined space and corresponds to the static contact point 261. The insulation partitioning between the first confined space and the fourth confined space during the movement of the moving contact 23 is implemented through a swing baffle 33 arranged on the moving contact 23 in the shape of an arc surface shape and an insulating chute 47 arranged on the housing 21 and matched with the swing baffle 33, the swing baffle 33 and the insulating chute 47 are located between the first confined space and the fourth confined space.

The second confined space is located on the right side of the first confined space. The static contact 26 is arranged in the second confined space. Only the static contact point 261 of the static contact 26 is exposed in the fourth confined space, and the rest is wrapped by an insulating material of the housing 21. The third confined space is located on the left side of the first confined space, and the trip 22 is arranged in the third confined space. The trip 22 is connected to the moving contact 23. The first confined space and the third confined space are separated by a first baffle and a second baffle that are in a staggered arrangement. A wiring groove for accommodating the first wiring sheet 221 and the second wiring sheet 231 is formed between the first baffle and the second baffle, which realizes not only insulation partitioning, but also assembly connection between the first wiring sheet 221 and the second wiring sheet 231. In this embodiment, the four relatively independent confined spaces are conducive to preventing the electric arc and a high-temperature gas and particles produced by the electric arc from entering the structure of the moving contact 23, the static contact 26 and the trip 22, and have good isolation and insulation functions.

Specifically, as shown in FIG. 1, the moving contact 23 is arranged on the rotating shaft 24, and the housing 21 is provided with a moving groove between the rotating shaft 24 and the arc-extinguishing chamber 37. The moving groove allows the moving contact 23 to move inside. An insulating structure is arranged around the moving groove. The insulating structure can prevent the electric arc and the high-temperature gas and particles produced by the electric arc from entering other parts in the housing 21 from the moving groove. As shown in FIG. 3, the insulating structure includes a swing baffle 33 arranged on the moving contact 23 in an arc surface shape. The insulating chute 47 matched with the swing baffle 33 is formed in the housing 21. The swing baffle 33 realizes insulating partitioning from the arc-extinguishing chamber 37 in the movement process of the moving contact 23.

As shown in FIG. 1, the housing 21 is provided with the trip 22 connected to the moving contact 23 at one side of the rotating shaft 24. The trip is connected to the first wiring sheet 221. The moving contact 23 is connected to the second wiring sheet 231. The first wiring sheet 221 is connected to the second wiring sheet 231. The insulating structure includes a first baffle and a second baffle that are staggered. A wiring groove for accommodating the first wiring sheet 221 and the second wiring sheet 231 is formed between the first baffle and the second baffle. The wiring groove is only used for accommodating the wiring sheet 221 and the wiring sheet 231, and the other parts are isolated by the first baffle and the second baffle. A space of the trip 22 and a space of the arc-extinguishing chamber 37 are isolated by an insulating material to avoid direct communication therebetween. The insulating structure that surrounds the moving groove is not only more conducive to the rapid transfer and extinguishing of the electric arc, but also is conducive to the high-temperature gas produced by the electric arc to be discharged from the gas outlets 29 on two sides of the housing 21, and can also prevent the high-temperature gas and particles produced by the electric arc from entering the rotating shaft and the trip and causing damages.

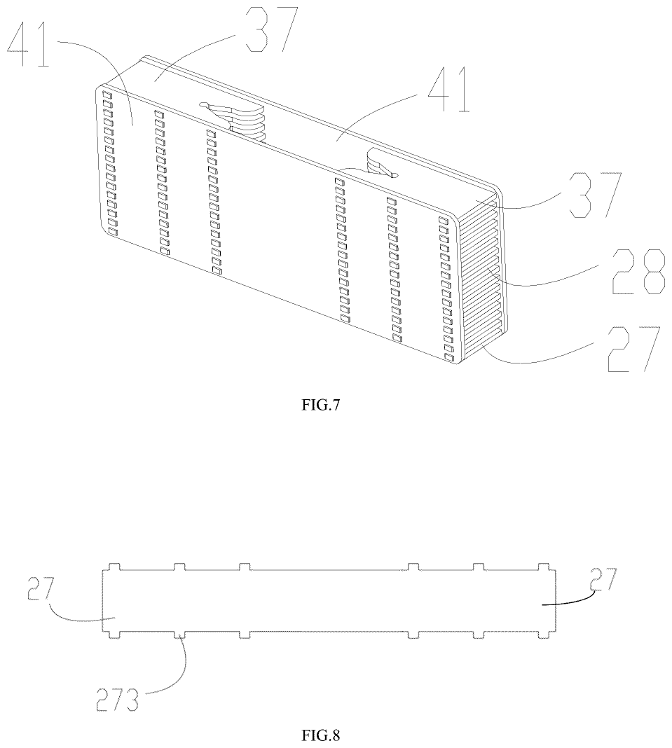

As shown in FIGS. 4 and 8, in this scheme, each arc-extinguishing grid 28 is provided with a second protrusion 283. The arc-striking grid 27 is provided with a first protrusion 273. The first protrusion 273 and the second protrusion 283 are both inserted into the corresponding holes of the partition plate 41. The second protrusions 283 are respectively arranged at two sides of the same arc-extinguishing grid 28, and the first protrusion 273 is respectively arranged at two sides of the arc-extinguishing grid 27. After all the arc-extinguishing grids 28 and the arc-striking grids 27 are assembled, the partition plates 41 on two sides are assembled into an integral arc-extinguishing chamber 37. As shown in FIG. 6, an integral grid group which is mounted together by all arc-extinguishing grids 28 is more convenient to mount; and meanwhile, the integral arc-extinguishing grid 28 group has better air tightness, and is more conducive to the air blowing effect on the electric arc.

as shown in FIG. 1, the two gas outlets 29 on two sides of the arc-extinguishing chamber 37 are in a direction perpendicular to the arc-extinguishing grids. The gas outlets 29 are located in the middle of the corresponding arc-extinguishing chamber 37 along an arrangement direction of the arc-extinguishing grids 28, and the gas outlets 29 on two sides are symmetrically arranged left and right. The upper and lower ends of the gas outlets 29 on two sides are respectively provided with a guide surface 312 of an inclined plane or a curved surface shape, which is conducive to a hot airflow generated by the electric arc to be discharged from the gas outlets 29.

As shown by dotted lines in FIGS. 10-11, when a short-circuit current is generated in a circuit, the moving contact 23 and the static contact 26 are repulsed due to reverse currents, and the moving contact 23 opens and stretches the electric arc around a pivot 331 (FIG. 3). The electric arc generated between the moving contact 23 and the static contact 26 is affected by a Lorentz force of the moving current. An arc root of one side of the electric arc moves from the static contact 261 to the second arc-striking sheet 43 connected to the static contact 26, an arc root of the other side of the electric arc moves in the direction of the arc angle 32 on the moving contact 23 along with an opening direction of the moving contact 23, and the electric arc is subjected to a force that causes it to move to the arc-extinguishing chamber 37. When the moving contact 23 is completely opened to the arc-striking sheet 42, the electric arc is transferred from the arc angle 32 of the moving contact 23 to the arc-striking sheet 42, and the electric arc completely enters the arc-extinguishing chamber 37 until it is extinguished.

In this embodiment, the arc-striking sheets and the second magnetizing sheets arranged on the outer side wall of the housing form the magnetizing mechanism, which is conducive to accelerating the electric arc extinguishing speed and is convenient to assemble. It may be understood that the internal magnetic structure may be separately arranged on a side of each arc-striking sheet, without making full of the existing arc-striking sheets, which also falls within the protection scope of the present invention.

It should be explained that, in the description of the present invention, the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. An arc-extinguishing mechanism, comprising an arc-extinguishing chamber, wherein the arc-extinguishing chamber comprises two partition plates and a plurality of arc-extinguishing grids arranged between the two partition plates; an arc-striking sheet which cooperates with a moving contact or a static contact is arranged at the top of the arc-extinguishing grids; the arc-extinguishing mechanism further comprises a first magnetizing mechanism; the first magnetizing mechanism comprises two first magnetizing sheets that are oppositely arranged on two sides of the plurality of arc-extinguishing grids, and an arc-striking structure is arranged at the bottom of the arc-extinguishing grids; the first magnetizing sheets are parallel to the partition plates; the first magnetizing sheets, the arc-striking structure and the arc-striking sheets form a first magnetic loop; and the first magnetic loop is used for generating a pushing force in a direction of an exhaust port of the arc-extinguishing chamber to an electric arc entering the arc-extinguishing chamber.

2. The arc-extinguishing mechanism according to claim 1, comprising the two arc-extinguishing chambers, wherein each of the two arc-extinguishing chambers is provided with the first magnetizing mechanism.

3. The arc-extinguishing mechanism according to claim 2, wherein the arc-extinguishing grids at the bottom of the two arc-extinguishing chambers are powered on to form the arc-striking structure, or the arc-extinguishing grids at the bottom of the two arc-extinguishing chambers are integrally molded to form the arc-striking structure.

4. The arc-extinguishing mechanism according to claim 1, wherein the arc-extinguishing mechanism further comprises a second magnetizing mechanism; the second magnetizing mechanism comprises two second magnetizing sheets that are arranged oppositely; the two second magnetizing sheets are arranged on two sides of a movement trajectory of an opening position and a closing position of the moving contact; the second magnetizing sheets and the arc-striking sheets form a second magnetic loop; and the second magnetic loop is used for generating a pushing force in a direction of a gas inlet of the arc-extinguishing chamber to an electric arc generated in disconnection.

5. The arc-extinguishing mechanism according to claim 1, wherein the arc-extinguishing chamber is arranged on the inner side of a housing, and the first magnetizing sheets are arranged on the outer side of the housing.

6. The arc-extinguishing mechanism according to claim 1, further comprising a magnetic block, wherein the magnetic block is arranged on a side of the static contact away from the moving contact and is located between the two second magnetizing sheets.

7. The arc-extinguishing mechanism according to claim 2, comprising two arc-striking sheets, which are a first arc-striking sheet and a second arc-striking sheet respectively; the first arc-striking sheet and the second arc-striking sheet cooperate with the static contact and the moving contact respectively; the arc-striking sheet comprises a contact portion and an arc-striking portion that are connected in a bending manner, wherein the contact portion of the first arc-striking sheet is connected to the static contact, and the arc-striking portion of the first arc-striking sheet extends to the upper side of one of the arc-extinguishing chambers; and an arc angle of the moving contact is in contact fit with the contact portion of the second arc-striking sheet when the moving contact is fully opened, and the arc-striking portion of the second arc-striking sheet extends to the upper side of the other arc-extinguishing chamber.

8. The arc-extinguishing mechanism according to claim 1, wherein each arc-striking sheet is provided with an arc-striking ditch.

9. The arc-extinguishing mechanism according to claim 5, wherein a first groove and a second groove are formed on the outer sides of two opposite side walls of the housing; and the first magnetizing sheets and the second magnetizing sheets are respectively mounted in the first groove and the second groove, which are covered with an insulating plate.

10. The arc-extinguishing mechanism according to claim 2, wherein a gas inlet is formed at one end of each of the two arc-extinguishing chambers that are close to each other, and a gas outlet is formed at one end of each of the two arc-extinguishing chambers that are away from each other; the two groups of arc-extinguishing chambers are symmetrically arranged at two ends of the bottom of the housing; each side wall at two ends of the housing is provided with two gas outlets that are symmetrically formed; and the two gas outlets correspond respectively to exhaust ports of the two groups of arc-extinguishing chambers.

11. The arc-extinguishing mechanism according to claim 10, wherein guide surfaces are respectively arranged at the upper and lower ends of the two sides of the gas outlets, and the guide surfaces have inclined or curved shapes.

12. The arc-extinguishing mechanism according to claim 2, wherein an arc-extinguishing groove is respectively formed at the end parts of at least part of arc-extinguishing grids in each group of arc-extinguishing chambers that are close to the other arc-extinguishing chamber; a diffusion groove that is communicated with the bottom of the arc-striking groove is formed on each arc-extinguishing grid; and a maximum inner diameter of the diffusion groove is greater than an inner diameter at the bottom of the diffusion groove.

13. The arc-extinguishing mechanism according to claim 2, wherein the two groups of arc-extinguishing chambers are symmetrically arranged at two ends of the bottom of the housing; a trip is arranged on the top side of one group of arc-extinguishing chambers; the static contact is arranged on the top side of the other group of arc-extinguishing chambers; and the moving contact is located between the trip and the static contact.

14. The arc-extinguishing mechanism according to claim 13, wherein the housing is provided with a fourth confined space accommodating the arc-extinguishing chambers, and a first confined space accommodating the moving contact; a rotating shaft connected to the moving contact is arranged in the first confined space; the moving contact is located in the first confined space; one end of the moving contact which is provided with the moving contact point extends into the fourth confined space; the insulation partitioning between the first confined space and the fourth confined space during the movement of the moving contact is implemented through a swing baffle arranged on the moving contact in the shape of an arc surface shape and an insulating chute arranged on the housing and matched with the swing baffle; a second confined space for accommodating the static contact is arranged in the housing; and the static contact is arranged in the second confined space, and only a static contact point of the static contact is exposed in the fourth confined space.

15. The arc-extinguishing mechanism according to claim 14, wherein a third confined space for accommodating the trip is formed in the housing; the trip is connected to a first wiring; the moving contact is connected to a second wiring sheet; the first wiring sheet is connected to the second wiring sheet; the first confined space and the third confined space are separated by a first baffle and a second baffle that are in a staggered arrangement; and a wiring groove for accommodating the first wiring sheet and the second wiring sheet is formed between the first baffle and the second baffle.
